(19) United States
(12) Patent Application Publication
(10) Pub. No.: US 2003/0074392 A1
(43) Pub. Date: Apr. 17, 2003

(54) Methods for a request-response protocol between a client system and an application server

(76) Inventors: Yogin Eon Campbell, Folsom, CA (US); Vance Maverick, San Francisco, CA (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 09/816,991

(22) Filed: Mar. 22, 2001

(51) Int. Cl. G06F 15/16

(52) U.S. Cl. 709/203; 707/501.1

(57) ABSTRACT

A method for a client system to exchange data with an application server running a decision optimization engine comprising generating a request document at the client system having request child elements, wherein at least one request child element comprises a command to the decision optimization engine, sending the request document to the application server, and receiving a response document from the application server generated by the decision optimization engine comprising response child elements. Also, a method for an application server running a decision optimization engine to exchange data with a client system comprising receiving a request document from the client system having request child elements, wherein at least one request child element comprises a command for the decision optimization engine, performing the command using the decision optimization engine, generating a response document using the decision optimization engine having response child elements, and sending the response document to the client system.

### BACKGROUND

1. Field of the Invention

The present invention relates to the field of application program interfaces, more specifically, to application program interfaces for exchanging data between an application server running a decision optimization engine and a client system.

2. Background Information

Companies that buy and sell high volumes of goods in fast-moving markets require technology and services that better enable them to maximize financial performance in real-time across commerce networks. Known solutions available on the market generally solve only highly specific elements of the general business problem, such as inventory and pricing management. They do not take into consideration the overall impact of buy and sell decisions in all their permutations, and therefore cannot provide a complete solution for optimizing profits and balancing risks for both the buy-side and sell-side of businesses.

Recently, decision optimization technology has been developed to help businesses balance strategic tradeoffs between costs and profits, and this technology uses real-time probabilistic modeling to capture all the “what if?” possibilities and variables in a given business environment. Decision optimization engines enable manufacturers to make the best possible and most efficient procurement plans, more reliably taking into account the risks of supply and demand. This technology allows businesses to develop superior business plans for optimizing profits and minimizing risks.

The software used in these decision optimization engines is typically developed independently of any software used to manage a particular manufacturers' business. Therefore, one problem that exists is how to integrate software tools associated with decision optimization engines into the overall planning and manufacturing process of the manufacturer. This type of integration requires bringing the manufacturer's data, such as product and component catalogs and historical demand information, into the systems running the decision optimization engine software, and then exporting the resulting plans to the manufacturer's execution systems.

### SUMMARY OF THE INVENTION

An embodiment of the invention includes a method to address the above problem by providing an application program interface that allows for the exchange of data between an application server running a decision optimization engine and a client system. According to this embodiment, the method begins by generating a request document at a client system, wherein the request document comprises a plurality of request child elements. Next, the request document is sent from the client system to an application server running a decision optimization engine. At the application server, the decision optimization engine is used to execute the request document and generate a response document, wherein the response document comprises a plurality of response child elements, and at least one of the response child elements corresponds to at least one of the request child elements. Finally, the response document is sent from the application server to the client system, and the client system then extracts and uses the data contained in the response document.

### BRIEF DESCRIPTION OF THE DRAWINGS

FIG. 1 is a block diagram of an Internet-like network shown as a representative environment for deployment of the present invention.

FIG. 2 is a block diagram of an analysis system hosted by one or more computer systems.

FIG. 3 is a graphical illustration of the paths traveled by a Request Document and a Response Document between an application server and a client system.

FIG. 4 is a block diagram of an embodiment of the data structure of a Request Document.

FIG. 5 is a block diagram of an embodiment of the data structure of a Response Document.

FIG. 6 illustrates an embodiment of a computer system configured to employ the methods of the invention.

### DETAILED DESCRIPTION OF THE PREFERRED EMBODIMENTS

An embodiment of the invention comprises a general integration application program interface (API) providing a request-response protocol between an application server running a decision optimization engine (also referred to as an analytic engine) and a client system. The client system sends a request for information to the application server, wherein this request document contains one or more commands. The application server then executes the commands, and returns a response document enumerating results that correspond to the commands in the request document. Every request document, and every response document, generally comprises a complete Extensible Markup Language (XML) document.

1. Network Architecture

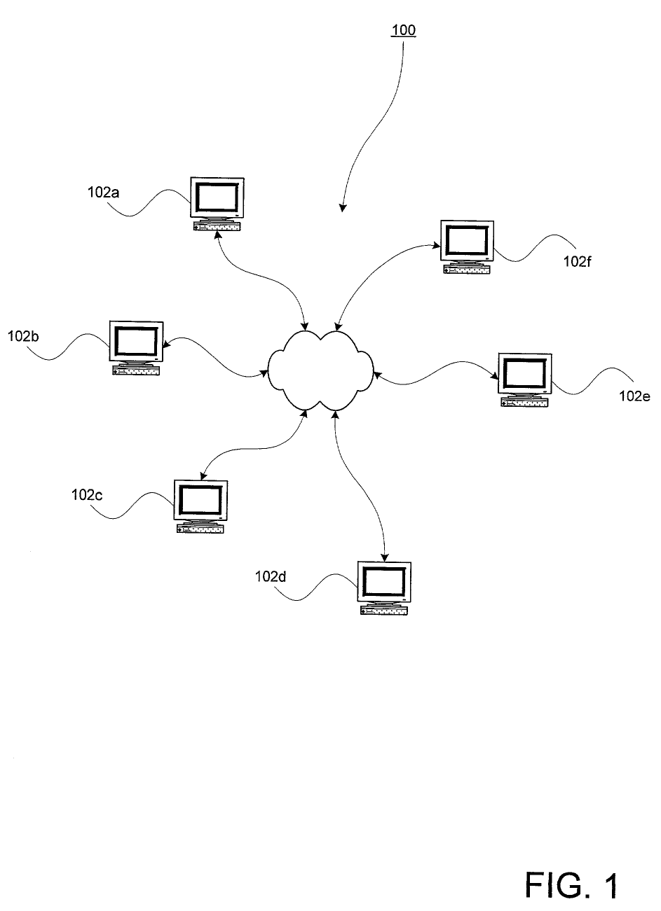

In FIG. 1, a computer network 100 is shown as a representative environment for an embodiment of the present invention. Computer network 100 is intended to be representative of the complete spectrum of computer network types including local-area networks, wide-area networks, the Internet, and Internet-like networks. Computer network 100 includes a number of computer systems, of which computer systems 102a through 102f are representative. Computer systems 102 are intended to be representative of the wide range of large and small computer and computer-like devices that are used in computer networks of all types. Computer systems 102 are specifically intended to include non-traditional computing devices such as personal digital assistants and web-enabled cellular telephones. The architecture of a computer system 102 is described in more detail below in Section 5.

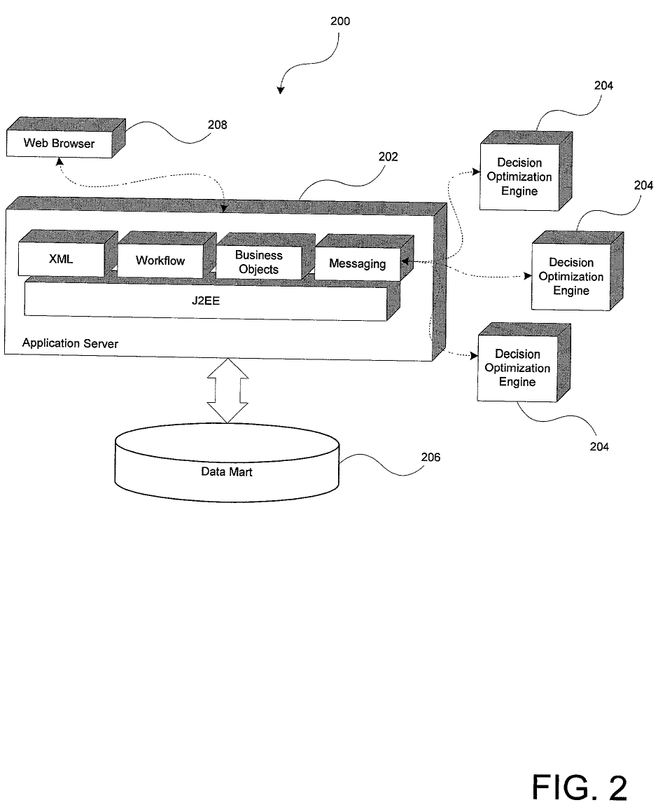

For the purposes of description, it may be assumed that computer network 100 includes an analysis system hosted by one or more computer systems 102. A representative implementation for a system of this type is shown in FIG. 2 as an analysis system 200. Analysis system 200 includes an application server 202 that coordinates one or more decision optimization engines 204. The term “server” refers to software on a computer system 102 or device on a network 100 that receives and answers requests for information. Typically, computer system 102 is also dedicated to storing data files and managing network resources, including network traffic. Decision optimization engines 204 are described in more detail below in Section 2.

Application server 202 interacts with a database 206 and any number of web browsers 208. Application server 202 manages web interactions, database access, XML-based data exchange, report design and delivery, and asynchronous messaging among engines. The server can be based on Java 2 Enterprise Edition (J2EE) standards.

2. The Decision Optimization Engine

Each of decision optimization engines 204 is computer software that provides a shared, preferably web-enabled framework for collaborative optimization of buy and sell decisions within and across a supply chain. Suppliers and manufacturers within the supply chain share information over a communications network (e.g. the Internet) so each company can optimize its own sourcing and revenue management decisions. Each supplier or manufacturer uses computer hardware and software, including computer systems, network interfaces, and server software, to communicate with other suppliers and manufacturers. Through this collaboration, companies can maximize financial performance across commerce networks, and realize previously unachievable gains in revenue capture, asset utilization, customer satisfaction, and trading liquidity. Decision optimization engines 204 help companies capture key business variables and objectives to identify the elements of their business model that have the greatest impact on financial performance. And, conversely, engines 204 help companies identify the elements that generate the highest risks. Simply put, the output of decision optimization engines 204 comprises risk-optimized buy/sell recommendations for optimal financial performance.

To be more specific, decision optimization engines 204 are stateless components offering a set of related analytics. Suppliers or manufacturers submit problem statements (in the form of request documents) to decision optimization engines 204. Each request document identifies an analysis to perform and includes all necessary input data. Decision optimization engines 204 output a solution in the form of a response document. Decision optimization engines 204 must define the structure/schema of its expected input and output. An example of a decision optimization engine such as decision optimization engine 204 is the Rapt Decision Optimization Platform, developed and available from Rapt, Inc., of San Francisco, Calif.

Each of decision optimization engines 204 includes an engine interface and an engine core. The engine interface handles XML-based I/O, message queue management, and provides standards-based APIs. The engine core processes the analytic requests for a set of related problems. For the particular implementation being described, engine interfaces are implemented as Java applications and engine cores implemented as compiled libraries of Matlab source code. Each engine interface communicates with its corresponding engine core through Java Native Interface (JNI) calls in which input and output filenames are passed. It will be apparent to one of skill in the art that the functionality described herein can be implemented in any one of a number of programming languages and environments.

The engine interface defines shared semantics for communication and collaboration between suppliers and manufacturers at the decision making layer. Using this interface, supply chain participants can signal replies or advise of plan changes to partners. They can intelligently and preemptively notify partners of changes in availability or consumption of critical resources. And they can continuously monitor supply/demand dynamics that determine their ability to hit revenue targets while reducing costs in total supply. An example of such an interface is the Rapt Dynamic Commerce Framework, also developed by and available from Rapt, Inc.

The engine interface uses embodiments of the present invention to provide a standards-based, two-way communications protocol for parsing and translating data and commands generated by decision optimization engine 204 into messages understandable by the servers of other systems operating within the supply chain or trading network, and vice versa. For clarity, these systems operating within the supply chain or trading network are referred to from here on as “clients” or “client systems.” Embodiments of the invention use a command infrastructure, which is a series of commands drawn from a defined command vocabulary, to provide the communications protocol. Using these embodiments, the engine interface links third party tools, independent software vendors, commerce network services providers, procurement and planning applications, and trading engines. Embodiments of the invention also use XML integration for both input and output, and further build on the command infrastructure by adding a query interface and a mechanism both for sharing data and for synchronizing planning activities across clients.

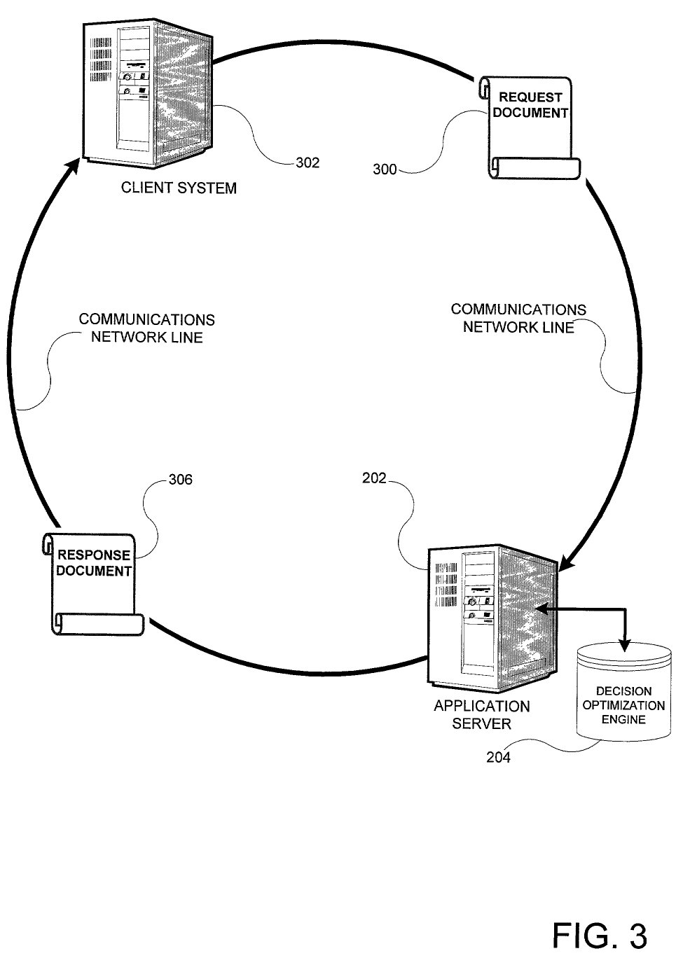

FIG. 3 is a block diagram illustrating the flow of information according to one embodiment of the invention in which communications between an application server running decision optimization engine 204 and a client system are enabled using Request Documents and Response Documents. A Request Document 300 is generated when a client system 302 requires data and/or one or more analyses from application server 202. Request Document 300 contains commands and requests that act as instructions for application server 202. Request Document 300 can be generated by software running on client system 302, or by software running on a separate computer system that is in communication with client system 302. Alternatively, Request Document 300 can be generated by a human programmer and uploaded into client system 302.

Next, Request Document 300 is transmitted to application server 202 which is running a decision optimization engine software 204. The transmission occurs over a communications network which can be a secure local network, a secure dedicated line, or even a public network such as the Internet. If the transmission occurs over the Internet, the data can be secured using known encryption techniques or certificates, including through the use of a standard secure protocol such as Secure Sockets Layer (SSL).

Once application server 202 receives Request Document 300, decision optimization engine 204 reads and executes the provided commands and requests. Decision optimization engine 204 then generates a Response Document 306 containing responses to the commands, and requests, including any data or analyses that were requested. Response Document 306 is then transmitted back to client system 302, typically over the same communications network. Request Document 300 and Response Document 306 are now described in further detail.

3. The Request Document

One embodiment of Request Document 300 generally comprises a series of commands drawn from the command infrastructure, operating on a data model that corresponds to decision optimization engine 204 running on the application server. Request Document 300 is typically written in XML format, conforming to a syntax specification defined in a document type definition (*.dtd) file.

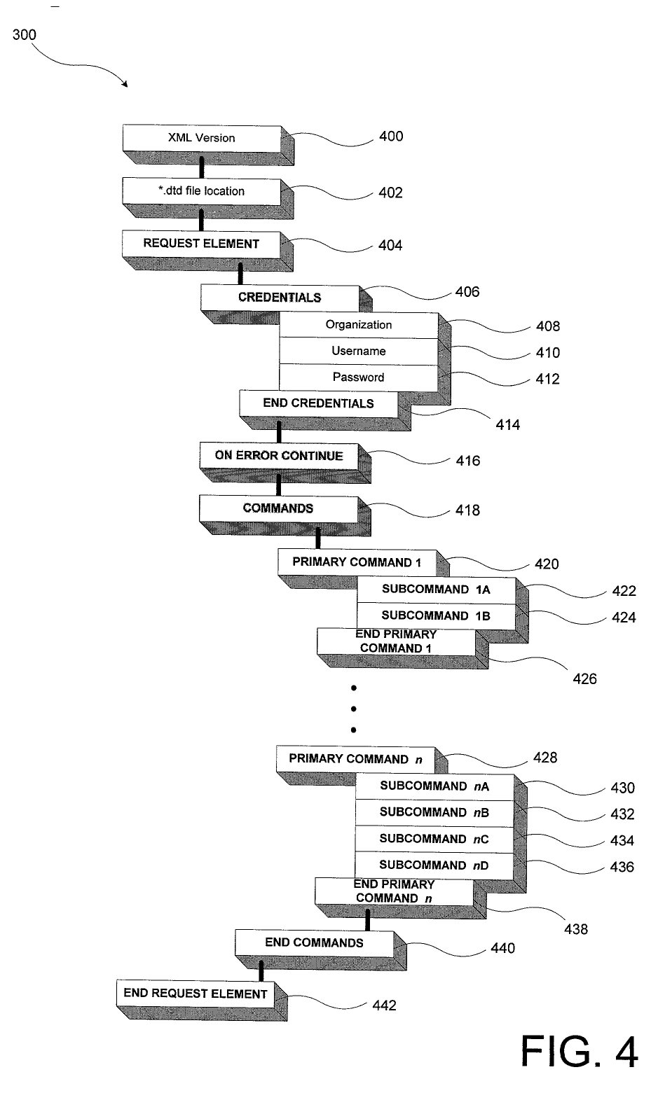

FIG. 4 illustrates Request Document 300 in block diagram form. In this embodiment, Request Document 300 comprises a plurality of data blocks 400 to 442. Although these data blocks are labeled herein in different ways, such as “root element,” “child element,” “primary command,” “subcommand,” etc., it is important to note that they are first and foremost simply data blocks. In FIG. 4, the first data block, data block 400, identifies the XML version being used. The second data block, data block 402, provides the name or location of the document type definition data file that defines the syntax specification of the document (i.e. how the mark-up tags in Request Document 300 should be interpreted by the application server).

The next data block in Request Document 300 is a root element, in this case, a Request Element 404. Request Element 404 is in turn made up of a plurality of request child elements. In this embodiment, Request Element 404 has three request child elements (which are shaded in FIG. 4). Each of these request child elements can themselves comprise further request child elements. Preferably, two of these request child elements are a Credentials Element 406 and a Commands Element 418. Please note that the labels “Credentials” and “Commands,” as well as “Request” and “Response,” are used for clarity and conciseness. The specific labels used on any child elements described herein are not necessarily definitive, and the child elements described herein can take on any of a number of labels apart from the ones used here. It is the specific function of each of the child elements that is important.

As illustrated in FIG. 4, the third request child element in this embodiment is an On Error Continue Element 416 that instructs application server 202 to continue processing Request Document 300 despite any errors that may be generated. If On Error Continue Element 416 is not present, application server 202 can be expected to cease executing Request Document 300 upon the occurrence of a single error. Finally, an End Request Element 442 signals to application server 202 that the end of the root element has been reached. This is the last data block of Request Element 404.

Returning to Credentials Element 406, this element comprises data that allows application server 202 to identify which client system 302 has sent Request Document 300 and is making the requests for data. Credentials Element 406 comprises request child elements that provide information to application server 202, such as an Organization 408 (that owns or operates client system 302 ), a Usemame 410, and a Password 412. This is similar to a login process, but without any formal authentication of client system 302. The end of Credentials Element 406 is signaled with an End Credentials Element 414.

Returning to Commands Element 418, this element includes a list of all of the commands that client system 302 is instructing application server 202 to execute. Commands Element 418 comprises a plurality of request child elements, herein labeled primary commands 420 and 428. The primary commands are the main commands or requests for which Request Document 300 was generated. It should be noted that Commands Element 418 can include any number of primary commands, depending upon the needs of client system 302. Therefore, there are no constraints on the number of primary commands that can be included in Commands Element 418. This is illustrated in FIG. 4 as primary command “1” 420 to primary command “n” 428, wherein n can be any natural integer. Some, but not all, of these primary commands will yield a response element in Response Document 306.

Primary commands 420 and 428 themselves include further request child elements that are herein labeled subcommands 422, 424, and 430 to 436. As is the case for the primary commands, there are no restrictions on the number of subcommands used in each primary command. For instance, in FIG. 4, primary command “1” 420 comprises subcommands “1A” 422 and “1B” 424. Primary command “n” 428 comprises subcommands “nA”430, “nB” 432, “nC” 434, and “nD” 436. Primary commands 420 and 428 end with their respective End Primary Command Elements 426 and 438. Examples of primary commands that can be included in Commands Element 418 are further discussed below.

After all of the primary commands and their subcommands are enumerated in Request Document 300, the end of Commands Element 418 is signaled by an End Commands Element 440. This is generally followed by an End Request Element 442 that signals the end of Request Element 404, and generally the end of Request Document 300.

In another embodiment of Request Document 300, a root element can be introduced to allow decision optimization engine 204 to support multiple products with varying “dialects” of the basic language. The root element can be named ProductQuery in this embodiment, and this root element can enable clients to detect what products are installed at the server site that is servicing them. The response to this root element can be a list of the products installed on the server.

4. The Response Document

As application server 202 uses decision optimization engine software 204 to execute Request Document 300, decision optimization engine 204 also generates a Response Document 306. Like Request Document 300, Response Document 306 is typically written in XML format, and conforms to a public syntax specification defined in a document type definition (*.dtd) file. Response Document 306 comprises responses to the individual request child elements found in Request Document 300, for instance, the primary commands and subcommands. A single Response Document 306 is typically generated for each Request Document 300.

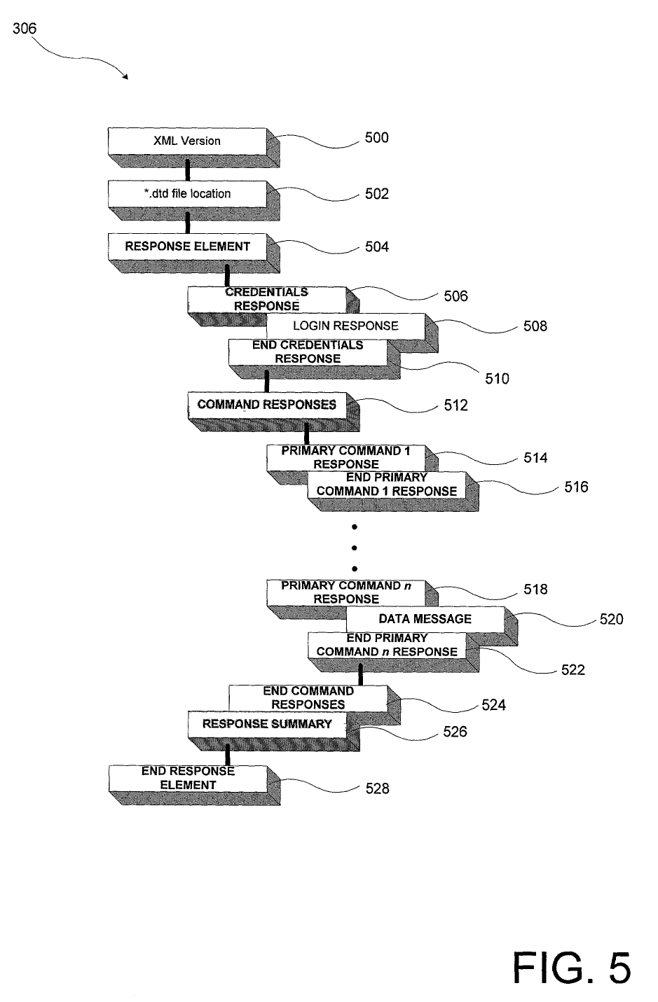

FIG. 5 is a block diagram illustrating one embodiment of Response Document 306. Like Request Document 300, this embodiment of Response Document 306 includes a number of data blocks 500 to 528, and begins with data blocks that provide information regarding the XML version being used (a data block 500 ), and the location of the document type definition file (a data block 502 ).

The next data block comprises a root element, in this case a Response Element 504. Response Element 504 in turn comprises a plurality of response child elements. In this embodiment, there are three response child elements (which are shaded in FIG. 5). The response child elements are generally responses to the request child elements present in Request Document 300, such as Credentials Element 406, and the primary commands and subcommands of Commands Element 418. Therefore many of the response child elements directly correspond to a request child element in Request Document 300. Often these response child elements will comprise a message indicating whether a particular request “succeeded” or “failed.” The response child elements can also comprise data blocks that provide information about Response Document 306 without necessarily corresponding to a request child element.

As shown in the embodiment of FIG. 5, the first response child element comprises a Credentials Response Element 506. Credentials Response Element 506 is generated in response to Credentials Element 406 in Request Document 300 and can inform client system 302 as to whether the credentials information supplied in Request Document 300 was valid. Credentials Response Element 506 can further comprise a Login Response Element 508 that specifically contains such information. The end of Credentials Response Element 506 is then signaled by End Credentials Response Element 510. The use of Credentials Response Element 506 is optional because, if the client system cannot be identified, Response Document 306 will typically not be generated.

Another response child element illustrated in FIG. 5 is a Command Responses Element 512. This element in turn comprises response child elements 514 and 518, which correspond to the primary commands of Commands Element 418 in Request Document 300. For instance, primary command “1” response 514 is generated in response to primary command “1” 420 of Request Document 300. And primary command “n” response 518 is generated in response to primary command “n” 428 of Request Document 300. Each primary command response ends with its respective end primary command responses 516 and 522. The end of Command Responses Element 512 is signaled by End Command Responses Element 524.

The number of response child elements present in Response Document 306 will depend on what request child elements are in Request Document 300. Please note that not all of the request child elements will generate a response child element. In addition, the primary command responses can further comprise data messages, as exemplified in FIG. 5 by data message 520. For example, if application server 202 was unable to execute primary command “n” (i.e. a “failed” response was returned), data message 520 may comprise an error element explaining why primary command “n” was not executed. As another example, data message 520 can comprise result data, such as the result of a data analysis that client system 302 requested application server 202 to perform.

Response Element 504 can also include a Response Summary Element 526 that has the value “completed” if all of the request child elements were executed, or the value “aborted” if some of them were skipped. Alternatively, Response Summary Element 526 can summarize which request child elements were successful and which ones failed.

In an alternative embodiment, Response Document 306 can include one or more data blocks that indicate how much time elapsed while executing Request Document 300. These data blocks can be added to each response child element individually, indicating how long each request child element took to execute, and one data block can be added towards the end of Response Document 306 to indicate how long the entire Request Document 300 took to execute. The value is the time (e.g., in milliseconds) taken by the command.

Finally, as was the case with Request Document 300, Response Element 504 ends with an End Response Element 528. This signals to client system 202 that the end of Response Document 306 has been reached.

5. Commands

The following is a description of many of the commands that can be included in Commands Element 418 of Request Document 300. Please note that the following are just a few embodiments of the commands that can be used, and many different embodiments of these commands exist. Furthermore, this list is only a sample of commands that can be included in Request Document 300, and other commands not described here can also be used.

### Organization Overview

Before discussing commands that are available, it is important to explain that data used by the invention, and in particular by decision optimization engine 204, can be organized in a multitude of different ways. Different organizational elements can be created and used to store different types of data. In one embodiment, organizational elements referred to herein as plans, scenarios, analyses, repositories, and planning environments can be used. These elements are explained here.

Organizational elements known as plans can be used to store lists of components required by a company to produce its product, along with the specific quantities needed for each component. Plans can therefore represent a company's component order for a given planning period.

Organizational elements known as scenarios can be used in conjunction with plans and can hold data relating to sets of assumptions about the client's products and the components required to build them. A scenario can include product parameters, component parameters, component consumptions, component interactions, and an allocation policy. A scenario can be the parameterization of all the demand, financial, and operational information for a portfolio of products and components across a set of time buckets (planning periods). The data input process can be either manual (through a user interface) or automated (e.g., by importing data from external systems).

Organizational elements known as analyses can also be used in conjunction with plans and scenarios and can hold data relating to evaluations of plans, which are generally performed by decision optimization engine 204. A risk analysis can evaluate plans under user-defined scenarios. A tornado analysis can show how sensitive an output is to changes in an input parameter. And a gating analysis can show which components are most likely to gate a product, and which products a component is likely to gate. A component is gating if a small increase in the plan for just that component would allow more product demand to be met.

The above organizational elements can be stored in electronic folders referred to herein as repositories and planning environments. A repository is a folder that can store scenarios, plans, and analyses. A repository can have one or more associated lists of products, components, and ownerships that are inherited by all the scenarios, plans, and analyses that the repository contains. And a planning environment is a higher-level folder used to store one or more repositories. The repositories stored can include an execution document repository, which is typically owned by the same user as the planning environment itself, and one or more working document repositories, one for every user who is added to the planning environment as a planner. Each user can access the documents in his or her own repository, access documents in the execution document repository, and access other user's working document repositories, depending on permissions set in the application.

### Commands for Planning Environments

Many commands act or take effect within a planning environment, and in a sequence of commands, many or all are likely to refer to the same planning environment. Therefore, before these commands can be used, the planning environment and user information must already have been set up by administrative commands. To choose a particular planning environment for a command to be executed within, a command to “Select a Planning Environment” (or SelectPlanningEnvironment in one embodiment of the XML code) can be used prior to the command itself. The command can generally require that the owner name be included, and if this information is omitted, the system can then look for a planning environment with the given name to which the current user belongs. This command can produce a “failed” child response element in Response Document 306 if there is no such planning environment, if the user does not have access to the named planning environment, or if there is more than one match (this is possible only if the owner name is omitted). Otherwise, this command generally produces a corresponding response child element in the response document.

For example, a command to create a scenario can specify which planning environment the scenario is to be added to, and therefore a command to “Select a Planning Environment” is used to specify this planning environment. Exemplary XML code to carry out this function would be:

<SelectPlanningEnvironment name=“name” [owner=“username”]>

<CreateScenario>
<name>name to be given to scenario</name>
</CreateScenario>

</SelectPlanningEnvironment>

Note that text enclosed within brackets denotes alternative code that can be used in place of code preceding it.

Planning environment commands typically also refer to a particular repository after a planning environment has been selected. This can be specified in the above XML code by an element labeled repository. The value of this element can be either a username, identifying a repository belonging to that user, or the special keyword execution, identifying the planning environment's execution repository. (The same repository could be identified by the user name or the planning environment's owner.) When the element is omitted, as here, the repository is the one owned by the current user.

Membership commands are planning environment commands that are carried out within a planning environment and manage the list of users who participate in a particular planning environment. They may be executed by the owner of the planning environment. One membership command is to “Add a Planner” (AddPlanner in one embodiment of the XML code) and can be used to add a user to the planning environment as a planner (the user's account must already have been created). This command generally produces no corresponding response child element. Exemplary XML code to carry out this function would be:

<AddPlanner>

<user>name</user>

</AddPlanner>

A membership command to “Change a Planner” (ChangePlanner in one embodiment of the XML code) can be used to reassign a user's working documents to a new user. This command can produce a “failed” child response element in Response Document 306 if the first user was not a member of the planning environment, or if the second user is not an existing account. Otherwise, this command generally produces no corresponding response child element. Exemplary XML code to carry out this function would be:

<ChangePlanner>

<user>name</user>
<newUser>name</newUser>

</ChangePlanner>

A membership command to “Remove a Planner” (RemovePlanner in one embodiment of the XML code) can be used to remove a user from a planning environment, but generally not from the application. In addition, any documents in the planning environment owned by this particular user can be deleted. This command generally produces no corresponding response child element. Exemplary XML code to carry out this function would be:

<RemovePlanner>

<user>name</user>

</RemovePlanner>

Other commands can be provided to manage planning environments. These commands can manipulate planning environments “from above,” that is, outside the context of any particular planning environment. One such command is to “Create a Planning Environment” (or CreatePlanningEnvironment in one embodiment of the XML code), which can create a new planning environment. If the owner is not specified, the method can default to the current user. This command generally produces no corresponding response child element in Response Document 306. Exemplary XML code to carry out this function would be:

<CreatePlanningEnvironment>

<name>name</name>
[<owner>name</owner>]
<startPeriod>period</startPeriod>
<endPeriod>period</endPeriod>
[<description>text</description>]

</CreatePlanningEnvironment>

The element description in the above XML code consists of user comments. The elements startPeriod and endPeriod can represent the first and last planning periods that may influence the planning period of interest. This can be provided because planning is rarely done one period at a time, so this allows a user to work on future planning periods simultaneously with a current planning period.

Two other commands are to “Get a Planning Environment” and to “Load a Planning Environment” (or GetPlanningEnvironment and LoadPlanningEnvironment in one embodiment of the XML code), which retrieve previously stored planning environments. These commands generally produce no corresponding response child elements in Response Document 306.

A command to “Delete a Planning Environment” (or DeletePlanningEnvironment in one embodiment of the XML code) can be used to delete the named planning environment. This command generally produces no corresponding response child element in Response Document 306. Exemplary XML code to carry out this function would be:

<DeletePlanningEnvironment>

<name>name</name>
[<owner>name</owner>]

</DeletePlanningEnvironment>

A command to “Rename a Planning Environment” (RenamePlanningEnvironment in one embodiment of the XML code) can be used to rename the named planning environment. This command can produce a “failed” child response element in Response Document 306 if the old name can't be matched, or if the new name is already in use. Otherwise, this command generally produces no corresponding response child element. Exemplary XML code to carry out this function would be:

<RenamePlanningEnvironment>

<name>name</name>
[<owner>name</owner>]
<newName>name</newName>

</RenamePlanningEnvironment>

A command to “Copy a Planning Environment” (CopyPlanningEnvironment in one embodiment of the XML code) can be used to create a copy of a planning environment under a new name. This command can produce a “failed” child response element in Response Document 306 if the old name can't be matched, or if the new name is already in use. Otherwise, this command generally produces no corresponding response child element. Exemplary XML code to carry out this function would be:

<CopyPlanningEnvironment>

<name>name</name>
[<owner>name</owner>]
<target>name</target>

</CopyPlanningEnvironment>

The element target above represents the name that the copy of the planning environment is given.

### Commands for Managing User Accounts

Commands can be developed and used to manage user accounts. One such command is to “Create a User” (Create User in one embodiment of the XML code), which can be used to add one or more user accounts to the system application (but not necessarily to any planning environments). This command can produce a “failed” child response element in Response Document 306 if the name is already in use. Otherwise, this command generally produces no corresponding response child element. Exemplary XML code to carry out this function would be:

<CreateUser>

<name>name</name>
<password>password</password>

</CreateUser>

Another management command is “Delete a User” (Delete User in one embodiment of the XML code), which deletes a user name from the application. The user identified by a newOwner element becomes the owner of any products and working documents that were owned by the deleted user. This command generally produces no corresponding response child element. Exemplary XML code to carry out this function would be:

<DeleteUser>

<name>name</name>
<newOwner>name</newOwner>

</DeleteUser>

A management command called “Freeze a User” (Freeze User in one embodiment of the XML code) can be used to freeze a named account. After this command is executed, the designated user will be unable to log into the account, however, product and document ownership will not be changed (as it is by Delete User). This command can produce a “failed” child response element in Response Document 306 if there is no such account in the database. Otherwise, this command generally produces no corresponding response child element. Exemplary XML code to carry out this function would be:

<FreezeUser>

<name>name</name>

</FreezeUser>

A management command called “Switch a User” (Switch User in one embodiment of the XML code) can be used to set the current user value which applies during the execution of the contained commands. Subsequent commands are unaffected. This command can produce a “failed” child response element in Response Document 306 if the named account is not found in the database. Otherwise, this command generally produces no corresponding response child element. Exemplary XML code to carry out this function would be:

<SwitchUser name=“name”>

...

</SwitchUser>

### Commands for Managing Scenarios

Commands can be provided for managing one or more scenarios, including commands to create, retrieve, set, delete, rename, copy, download, update, or modify a scenario. One such scenario command is to “Create a Scenario” (CreateScenario in one embodiment of the XML code) and can be used to create a new scenario in the named planning environment, and in particular in the repository of the current user or the specified planner. This command can produce a “failed” child response element in Response Document 306 if the name is already in use, or the current user does not have access to the repository. Otherwise, this command generally produces no corresponding response child element. Exemplary XML code to carry out this function would be:

<CreateScenario>

<name>name</name>
[<repository>name</repository>]
[<description>text</description>]
[<planPublishDate>DateTime</planPublishDate>]

</CreateScenario>

The element planPublishDate can represent the date the plan is finalized. This provides a cut-off date for permitting changes to a scenario.

A scenario command to “Get a Scenario” (GetScenario in one embodiment of the XML code) can be used to look up a named scenario. If no user is specified, the default user can be the current user. This command can produce a scenario element as a child response element in Response Document 306. Exemplary XML code to carry out this function would be:

<GetScenario>

<name>name</name>
[<repository>username</repository>]

</GetScenario>

A scenario command to “Get a Master Scenario” (GetMasterScenario in one embodiment of the XML code) can be used to get a master scenario for a given planning environment. This command can produce a scenario element as a child response element in Response Document 306. Exemplary XML code to carry out this function would be:

<GetMasterScenario/>

<name>name</name>

</GetMasterScenario>

A scenario command to “Set a Master Scenario” (SetMasterScenario in one embodiment of the XML code) can be used to set the master scenario for a given planning environment. The name provided must identify a scenario stored in the execution repository. This command can produce a scenario element as a child response element in Response Document 306. Exemplary XML code to carry out this function would be:

<SetMasterScenario>

<name>name</name>

</SetMasterScenario>

A scenario command to “Delete a Scenario” (DeleteScenario in one embodiment of the XML code) can be used to delete a scenario. This command generally produces no corresponding response child element. Exemplary XML code to carry out this function would be:

<DeleteScenario>

<name>name</name>
[<repository>username</repository>]

</DeleteScenario>

A scenario command to “Rename a Scenario” (RenameScenario in one embodiment of the XML code) can be used to rename a scenario within its containing repository. This command can produce a “failed” child response element in Response Document 306 if the old name can't be matched, or if the new name is already in use. Otherwise, this command generally produces no corresponding response child element. Exemplary XML code to carry out this function would be:

<RenameScenario>

<name>name</name>
[<repository>name</repository>]
<newName>name</newName>

</RenameScenario>

A scenario command to “Copy a Scenario” (CopyScenario in one embodiment of the XML code) can be used to copy a scenario, either within one repository or between repositories in one planning environment. Both repository and targetRepository can default to the current user's repository. This command generally produces no corresponding response child element. Exemplary XML code to carry out this function would be:

<CopyScenario>

<name>name</name>
[<repository>name</repository>]
<target>name</target>
[<targetRepository>name</targetRepository>]

</CopyScenario>

A scenario command to “Download a Scenario” (DownloadScenario in one embodiment of the XML code) can be used to download a scenario of the execution document repository. The arguments below specify a target scenario in a working repository. If the scenario already exists, it can simply be overwritten. This command generally produces no corresponding response child element. Exemplary XML code to carry out this function would be:

<DownloadScenario>

<name>name</name>
[<repository>name</repository>]

</DownloadScenario>

A scenario command to “Update a Scenario” (UpdateScenario in one embodiment of the XML code) can be used to move parameters between a scenario in a working repository and a master scenario. In an embodiment, the element updateMode in the XML code below may have one of three values: up (wherein changes are propagated up from the working document repository), down (wherein changes are propagated down from the execution document repository), and both (wherein the planner's changes are propagated up, then any changes in the working document depository are propagated down). This last value is the default value for updateMode. This command generally produces no corresponding response child element. Exemplary XML code to carry out this function would be:

<UpdateScenario>

<name>name</name>
[<repository>name</repository>]
[<updateMode value=“mode” />]

</UpdateScenario>

A scenario command to “Modify a Scenario” (ModifyScenario in one embodiment of the XML code) can be used to alter a parameter across the board within a scenario. Within a “Modify a Scenario” command, an element scenarioItem (shown in the XML code below) can represent a product or a component. The element scenarioParameter (also shown below) can be used to identify numerical parameters for either a product or a component. And the element target (also below) can name a new scenario (in which case the original scenario will not be changed and the modified values will be saved into the new scenario—it is an error for target to name an existing scenario). This command generally produces no corresponding response child element. Exemplary XML code to carry out this function would be:

<ModifyScenario>

<name>name</name>
[<repository>name</repository>]
<scenarioItem value=“type” />
<scenarioParameter value=“parameter” />
<modification>modification</modification>
[<target>name</target>]

</ModifyScenario>

The modification performed can be an absolute modification, where the new value is simply applied verbatim (in one embodiment the XML code for this can be <AbsoluteModification>value</AbsoluteModification>), or it can be a relative modification, where the new value is interpreted as a signed percentage (in one embodiment the XML code for this can be <RelativeModification>value</RelativeModification>). For example, a relative modification value of “+10” can cause all values to be increased by 10%.

### Commands for Managing Plans

Decision optimization engine 204 can calculate a profit-maximizing or cost minimizing component plan based on a given scenario, and it can analyze the expected results of a given component plan under a given scenario. To manage plans, commands to create, retrieve, delete, rename, copy, download, update, and modify the plan can be provided.

A command to “Create a Plan” (CreatePlan in one embodiment of the XML code) can be used to create a new plan in the named planning environment, in the repository of the current user or the specified planner. This command can produce a “failed” child response element in Response Document 306 if the name is already in use, or the current user does not have access to the repository. Otherwise, this command generally produces no corresponding response child element. Exemplary XML code to carry out this function would be:

<CreatePlan>

<name>name</name>
[<repository>name</repository>]
[<description>text</description>]

</CreatePlan>

A command to “Get a Plan” (GetPlan in one embodiment of the XML code) can be used to retrieve a plan. This command can produce a number of different child response elements in Response Document 306. An “error” response element can be produced if there is an error such as not being able to locate a specified plan. A “not ready” response element can be produced if the plan is still being generated by decision optimization engine 204. A “failed” response element can be produced if decision optimization engine 204 fails while trying to generate the specified plan. And an actual plan can be produced as the response element if no errors are encountered. Exemplary XML code to carry out this function would be:

<GetPlan>

<name>name</name>
[<repository>name</repository>]
[<wait>Boolean</wait>]

</GetPlan>

The wait option given above affects processing only if the plan is being generated by decision optimization engine 204 and has not yet completed. If so, and the value supplied is “true”, the command will wait until the plan is available.

A command to “Get a Master Plan” (GetMasterPlan in one embodiment of the XML code) can be used to retrieve a master plan. This command can produce a number of different child response elements in Response Document 306. An “error” response element can be produced if there is an error such as not being able to locate a specified master plan. A “not ready” response element can be produced if the master plan is still being generated by decision optimization engine 204. A “failed” response element can be produced if decision optimization engine 204 fails while trying to generate the specified master plan. And an actual plan can be produced as the response element if no errors are encountered. Exemplary XML code to carry out this function would be similar to that given above to retrieve a plan.

A command to “Set a Master Plan” (SetMasterPlan in one embodiment of the XML code) can be used to set a master plan for a given planning environment. The name can identify a plan in the execution repository. This command can produce a plan element as a child response element in Response Document 306 if successful. Exemplary XML code to carry out this function would be:

<SetMasterPlan>

<name>name</name>

</SetMasterPlan>

A command to “Delete a Plan” (DeletePlan in one embodiment of the XML code) can be used to delete a plan. The name must identify a plan in the execution repository. This command can produce a “failed” child response element in Response Document 306 if the names required in the XML code below do not match. Otherwise, this command generally produces no corresponding response child element Exemplary XML code to carry out this function would be:

<DeletePlan>

<name>name</name>
[<repository>name</repository>]

</DeletePlan>

A command to “Rename a Plan” (RenamePlan in one embodiment of the XML code) can be used to rename a plan within the containing repository. This command generally produces no corresponding response child element. Exemplary XML code to carry out this function would be:

<RenamePlan>

<name>name</name>
[<repository>name</repository>]
<newName>name</newName>

</RenamePlan>

A command to “Copy a Plan” (CopyPlan in one embodiment of the XML code) can be used to copy a plan, within one repository or between repositories in one planning environment. The elements repository and targetRepository in the XML code below default to the current user's repository. This command generally produces no corresponding response child element. Exemplary XML code to carry out this function would be:

<CopyPlan>

<name>name</name>
[<repository>name</repository>]
<target>name</target>
[<targetRepository>name</targetRepository>]

</CopyPlan>

A command to “Download a Plan” (DownloadPlan in one embodiment of the XML code) can be used to download a master plan of the execution document repository. The arguments below can specify a target plan in a working repository. If the plan already exists, it may be overwritten. This command generally produces no corresponding response child element. Exemplary XML code to carry out this function would be:

<DownloadPlan>

<name>name</name>
[<repository>name</repository>]

</DownloadPlan>

A command to “Update a Plan” (UpdatePlan in one embodiment of the XML code) can be used to move parameters between a plan in a working repository and the master plan. The element updateMode in the XML code below may have one of three values: up (where changes are propagated up from the working document repository), down (where changes are propagated down from the execution document repository), and both (where a planner's changes are propagated up, then any changes in the working document repository are propagated down-this can be the default value). This command generally produces no corresponding response child element. Exemplary XML code to carry out this function would be:

<UpdatePlan>

<name>name</name>
[<repository>name</repository>]
[<updateMode value=“mode” />]

</UpdatePlan>

A command to “Modify a Plan” (ModifyPlan in one embodiment of the XML code) can be used to modify a single parameter throughout a plan. Again, the modification performed can be an absolute modification, where the new value is simply applied verbatim, or it can be a relative modification, where the new value is interpreted as a signed percentage. If the element target in the XML code below is provided, it names a new plan. In this case, the original plan will not be changed, the modified values will be saved into the new plan. It is an error for target to name an existing plan. This command generally produces no corresponding response child element. Exemplary XML code to carry out this function would be:

<ModifyPlan>

<name>name</name>
[<repository>name</repository>]
<modification>modification</modification>
[<target>name</target>]

</ModifyPlan>

### Commands for Performing Analyses and Optimizations

Other commands that client system 302 can include in Request Document 300 are commands that instruct application server 202 to perform data analyses and optimizations on the client's data (i.e. the client's scenarios and plans) using decision optimization engine 204. These commands generally do result in one or more response child elements in Response Document 306 containing the specific analyses that were requested.

These commands can include requests that application server 202 perform a risk analysis, a gated product analysis (a gated product is one that could be produced in a higher quantity if not for a shortage of a certain component), a gating components analysis (this is the certain component that is preventing one more unit of a product from being produced), and a tornado analysis (in a tornado analysis, some parameter of the products or components is varied, and the result reflects the resulting variability in some value function computed from that input). Client system 302 can also request that application server 202 regenerate an analysis (i.e. update an existing analysis by rerunning the same computation), retrieve an analysis, create an optimal plan, regenerate an optimal plan, and load a set of data for the analysis.

A command to “Create an Analysis” (CreateAnalysis in one embodiment of the XML code) can be used to create an analysis. This command generally produces an analysis as the response child element in Response Document 306. The element analysisType in the XML code below represents the type of an analysis that the user is requesting, such as a risk analysis, a gating components analysis, a gated products analysis, a tornado analysis, an executive analysis, or an efficient frontier analysis. The element analysisParams in the code below represents contains XML elements with further parameters required by the particular analysis type. Exemplary XML code to carry out this function would be:

<CreateAnalysis>

<name>name</name>
[<repository>name</repository>]
<analysisType value=“type”/>
<analysisParams>AnalysisParams</analysisParams>
[<wait>Boolean</wait>]

</CreateAnalysis>

A command to “Abort an Analysis” (AbortAnalysis in one embodiment of the XML code) can be used to abort a pending or running analysis. This command can produce a “failed” child response element in Response Document 306 if the analysis is not found, or if it is not in one of these states. Otherwise, this command generally produces no corresponding response child element. Exemplary XML code to carry out this function would be:

<AbortAnalysis>

<name>name</name>
[<repository>name</repository>]
<analysisType va1ue=“type”/>

</AbortAnalysis>

A command to “Delete an Analysis” (DeleteAnalysis in one embodiment of the XML code) can be used to delete an analysis. This command can produce a “failed” child response element in Response Document 306 if the analysis is not found. Otherwise, this command generally produces no corresponding response child element. Exemplary XML code to carry out this function would be:

<DeleteAnalysis>

<name>name</name>
[<repository>name</repository>]
<analysisType value=“type”/>

</DeleteAnalysis>

A command to “Regenerate an Analysis” (RegenerateAnalysis in one embodiment of the XML code) can be used to update an existing analysis by rerunning the same computation. If the element “wait” in the XML code below is set to “true”, then a successful response will contain the resulting analysis data as the response child element in Response Document 306. Exemplary XML code to carry out this function would be:

<RegenerateAnalysis>

<name>name</name>
[<repository>name</repository>]
<analysisType value=“type”/>
[<wait>Boolean</wait>]

</RegenerateAnalysis>

A command to “Get an Analysis” (GetAnalysis in one embodiment of the XML code) can be used to retrieve an analysis. This command can produce a number of different child response elements in Response Document 306. An “error” response element can be produced if there is an error such as not being able to locate a specified analysis. A “not ready” response element can be produced if the analysis is still being generated by decision optimization engine 204. A “failed” response element can be produced if decision optimization engine 204 fails while trying to generate the analysis. And an actual analysis can be produced as the response element if no errors are encountered. Exemplary XML code to carry out this function would be as follows:

<GetAnalysis>

<name>name</name>
[<repository>name</repository>]
<analysisType value=“type”/>
[<wait>Boolean</wait>]

</GetAnalysis>

A command to “Create an Optimal Plan” (CreateOptimalPlan in one embodiment of the XML code) can be used to run an optimization, thereby creating a plan. If successful, this command can produce a plan as a child response element in Response Document 306. There can be many parameters needed to create a plan. As seen in the XML code below, an element name can create a name for new plan; the element repository can specify where the plan should be created (the default can be a current user's repository); the element scenario can specify a scenario to use for the input parameters; the element optimization can specify whether profit or cost should be optimized; the element analysisMode can specify the extent to which a business can react once they know what demand for their product will be; the element confidenceLevel can specify a desired confidence level for analysis, such as by a percentage; the element supplyConstraint can specify whether supply constraints are respected in working out the plan; the element leadtimeConstraint can specify whether leadtime constraints are respected in working out the plan; and as described above, the element wait can make the command wait until the plan is available if the value of wait is “true”. Exemplary XML code to carry out this function would be:

<CreateOptimalPlan>

<name>name</name>
[<repository>name</repository>]
<scenario>name</scenario>
<optimization value=“type”>
<analysisMode value=“mode”>
[<description>text</description>]
<confidenceLevel>percentage</confidenceLevel>
[<supplyConstraint>Boolean</supplyConstraint>]
[<leadtimeConstraint>Boolean</leadtimeConstraint>]
[<wait>Boolean</wait>]

</CreateOptimalPlan>

A command to “Abort an Optimal Plan” (AbortOptimalPlan in one embodiment of the XML code) can be used to abort a pending or running optimization, identified by the name of the plan which is to be generated. This command can produce a “failed” child response element in Response Document 306 if the plan is not found, or if it is not in one of these states. Otherwise, this command generally produces no corresponding response child element. Exemplary XML code to carry out this function would be:

<AbortOptimalPlan>

<name>name</name>
[<repository>name</repository>]

</AbortOptimalPlan>

A command to “Regenerate an Optimal Plan” (RegenerateOptimalPlan in one embodiment of the XML code) can be used to update an existing plan by rerunning the same optimization, identified by plan name within a repository. If the element wait in the XML code below is set to “true”, then a successful response will contain the resulting plan as the response child element in Response Document 306. If the plan does not exist, a “failed” element will be the response child element. Exemplary XML code to carry out this function would be:

<RegenerateOptimalPlan>

<name>name</name>
[<repository>name</repository>]
[<wait>Boolean</wait>]

</RegenerateOptimalPlan>

### Commands for Data Loading

A command to “Load Source Data” (LoadSourceData in one embodiment of the XML code) can be used to load a set of source data for the whole enterprise. This data can apply within a single period, and can obliterate any previous source data for the same period. The element referenceDate in the XML code below can specify an effective date for the change. The data can be loaded across the entire planning period that includes that date. The elementperiodName below can specify a new name for the period. If the element validation is present in the XML code, the source data is validated against rules specified in a server-side configuration file (typically a data spreadsheet file). If a validation was specified, then this command will produce a Data Validation Results element as a child response element in Response Document 306. Otherwise, this command generally produces no corresponding response child element. Exemplary XML code to carry out this function would be:

<LoadSourceData>

<referenceDate>Date/NestedDate</referenceDate>
<periodName>period</periodName>
[<validation value=“mode”>]
<SourceData>
</SourceData>

</LoadSourceData>

A command to “Extract Source Data” (ExtractSourceData in one embodiment of the XML code) can be used to extract source data for a period from the database. This command generally produces a “source data” element as a child response element in Response Document 306. Otherwise, this command generally produces a “failed” element if the period cannot be matched. Exemplary XML code to carry out this function would be:

<ExtractSourceData>

<period>period</period>

</ExtractSourceData>

6. Exemplary Response Child Elements

The above commands were embodiments of command elements that can be used in Request Document 300. Many of the above commands yield response child elements in Response Document 306. The following are a few examples of embodiments of response child elements in XML form. Please note that these are just a few embodiments of response child elements that can appear in Response Document 306, and many other embodiments of these response child elements exist. Furthermore, other response child elements not described here can also be used.

A plan response child element can be represented in XML as follows:

<Plan>

[<description>text</description>]
<created>DateTime</created>
<lastModified>DateTime</lastModified>
<ComponentLevel .../>*

</Plan>

The element ComponentLevel in the above XML code can be represented as follows:

<ComponentLevel>

<component>name</component>
<period>period</period>
<level>level</level>
[<levelStatus value=“status”>]
[<description>text</description>]

</ComponentLevel>

The element component above can represent a sub-assembly, part, ingredient, or raw material consumed in the production of a higher-level assembly or product. Components can either be configured into a platform or sold directly as non-configured components. The code above can also include a level element that represents the quantity of the component, in units, to be procured in a given planning period, and a levelStatus element that consists of one of three values describing whether the system is free to alter this procurement level. For example, some component orders cannot be changed in the present planning period because of leadtime constraints. The three values for the levelStatus element are “actionable” (where a decision has to be made in the current planning period), “fixed” (where no decision has to be made in the current planning period because a decision has already been made because of the leadtime constraints), and “free” (where the optimization has made a best guess about the decision for the current planning period).

A scenario response child element can be represented in XML as follows:

<Scenario>

<name>name</name>
[<description>text</description>]
<created>DateTime</created>
<lastModified>DateTime</lastModified>
[<planPublishDate>DateTime<planPublishDate>]
<ScenarioProductInfo ... />*
<ScenarioComponentInfo ... />*
<ScenarioConsumption ... />*
<ScenarioProductInteraction ... />*

</Scenario>

The element ScenarioProductInfo in the above XML code can include product information, can elaborate upon and add onto previously stored product information, and can include the period in which the settings apply. This element can comprise another block of XML code, as follows:

<ScenarioProductInfo>

<ProductInfo ... />
<period>period</period>
[<description>text</description>]

</ScenarioProductInfo>

The element ScenarioComponentInfo in the scenario response child element can include component information, and can elaborate upon and add onto previously stored component information. It can also include a levelStatus element that consists of one of three values describing the planning status of the component level, “actionable” (where a decision has to be made in the current planning period), “fixed” (where no decision has to be made in the current planning period because a decision has already been made because of the leadtime constraints), and “free” (where the optimization has made a best guess about the decision for the current planning period). This element can also consist of an XML block as follows:

<ScenarioComponentInfo>

<ComponentInfo ... />
<period>period</period>
[<levelStatus value=“status”>]
[<description>text</description>]

</ScenarioComponentInfo>

The element ScenarioConsumption in the scenario response child element above can include consumption information, can elaborate upon and add onto previously stored consumption information, and can include the period in which the settings apply. This element can comprise another block of XML code, as follows:

<ScenarioConsumption>

<Consumption ... />
<period>period</period>
[<description>text</description>]

</ScenarioConsumption>

And the element ScenarioProductInteraction in the scenario response child element above can include product information concerning interactions between two products (e.g. synergy or cannibalization), can elaborate upon and add onto previously stored product interaction information, and can include the period in which the settings apply. This element can comprise another block of XML code, as follows:

<ScenarioProductInteraction>

<ProductInteraction ... />
<period>period</period>
[<description>text</description>]

</ScenarioProductInteraction>

7. Computer System Architecture

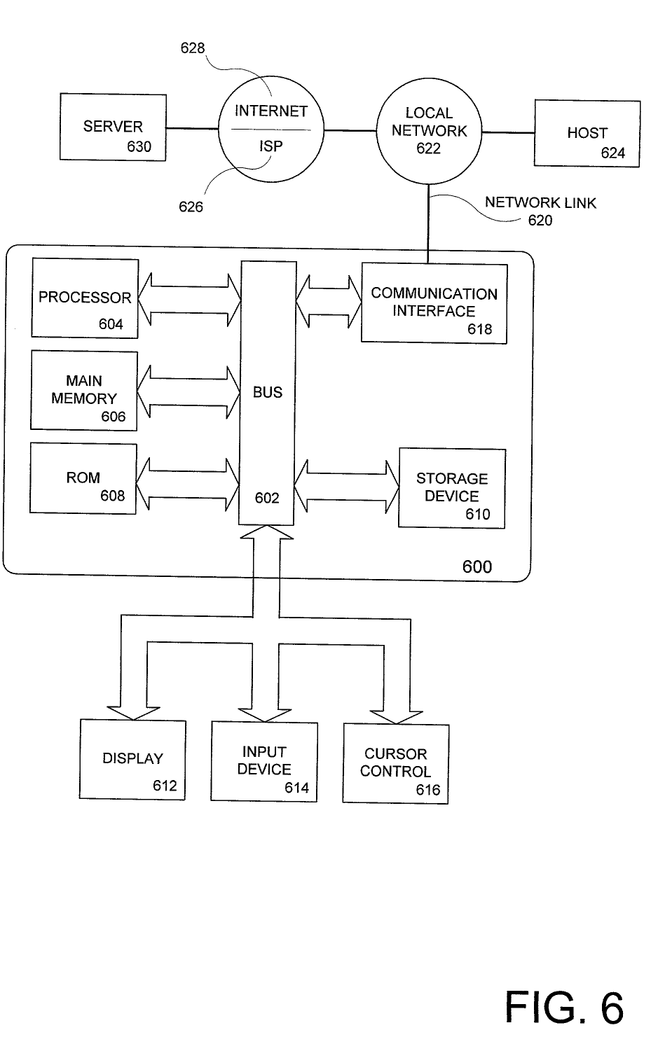

FIG. 6 is a block diagram of an exemplary computer system 600 upon which embodiments of the invention can be implemented. The computer system of FIG. 6 can be used for application server 202, and/or for client system 302.

Computer system 600 includes a bus 602, or other communication mechanism for communicating information, and a processor 604 coupled with bus 602 for processing information. Computer system 600 also includes a main memory 606, such as a random access memory (“RAM”), or other dynamic (or “volatile”) storage device, coupled to bus 602. Main memory 606 stores information and instructions executed by processor 604 during execution. Main memory 606 also stores temporary variables or other intermediate information during execution of instructions by processor 604. Computer system 600 further includes a read only memory (“ROM”) 608 or other static (or “persistent”) storage device (e.g., FLASH, PROM, EEPROM, etc.) coupled to bus 602. ROM 608 stores static information and instructions for processor 604. It is worth noting that one or more banks of memory can comprise ROM 608. A storage device 610, such as a magnetic disk or optical disk (or “hard disk”, or “hard drive”), or another form of persistent storage device, is coupled to bus 602. Storage device 610 uses a computer readable medium to store information such as data structures and instructions, for example, Request Document 300 or Response Document 306, processor executable instructions (e.g. decision optimization engine software 204 or other application programs) configured to carry out the methods described above with reference to application server 202 and client system 302, and/or structures relating to the operating system or application programs that use the operating system. These items can also be stored in a database residing on storage device 610.

In some embodiments, computer system 600 can be coupled via bus 602 to a display device 612, such as a cathode ray tube (“CRT”) or an active or passive-matrix display. An input device 614, including alphanumeric and other keys, can also be coupled to bus 602. Input device 614 communicates information and command selections to processor 604. Another type of user input device is cursor control 616, such as a mouse, trackball, or cursor direction keys, for communicating direction information and command selections to processor 604 and for controlling cursor movement on display 612. This input device 614 typically has two degrees of freedom in two axes, a first axis (e.g., x) and a second axis (e.g., y), that allows the device to specify positions in a plane.

According to an aspect of the invention, processor 604 in computer system 600 executes one or more sequences of instructions (i.e. software 405, such as an XML parser), contained in main memory 606. Such instructions are read into main memory 606 from another computer-readable medium, such as storage device 610 or ROM 608. The instructions can be executable object code or interpreted code that is processed by a run-time engine (e.g., Javascript).

Execution of the sequences of instructions contained in main memory 606 causes processor 604 to perform the methods of the invention as described herein, such as the methods described with reference to application server 202 and/or client system 302 above. In alternative embodiments, hard-wired circuitry can be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium can take many forms, including but not limited to, non-volatile media, volatile media, and transmission media. Non-volatile media includes, for example, optical or magnetic disks, such as storage device 610. Volatile media includes dynamic memory, such as main memory 606.

Transmission media includes coaxial cables, copper wire and fiber optics, including the wires that comprise bus 602. Transmission media can also take the form of acoustic or light waves, such as those generated during radio-wave and infrared data communications.

Common forms of computer-readable media include, a floppy disk, a flexible disk, a hard disk, a magnetic tape, or any other magnetic media, a CD-ROM, any other optical media, punchcards, a paper-tape, any other physical media with patterns of holes, a RAM, a ROM, a FLASH, or any other memory chip or cartridge, a carrier wave as described hereinafter, or any other media from which a computer can read.

Various forms of computer-readable media can be involved in carrying one or more sequences of one or more instructions to processor 604 for execution. For example, the instructions can initially be carried on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector coupled to bus 602 can receive the data carried in the infrared signal and place the data on bus 602. Bus 602 carries the data to main memory 606, from which processor 604 retrieves and executes the instructions. The instructions received by main memory 606 can optionally be stored on storage device 610 before or after execution by processor 604.

Computer system 600 also includes a communication interface 618 coupled to bus 602. Communication interface 618 provides a two-way data communication coupling to a network link 620 that is connected to a local network 622. For example, communication interface 618 can be an integrated services digital network (“ISDN”) card, or a modem to provide a data communication connection to a corresponding type of telephone line. As another example, communication interface 618 can be an Ethernet card to provide a data communication connection to a compatible local area network (“LAN”). Wireless links can also be implemented. In any such implementation, communication interface 618 sends and receives electrical, electromagnetic or optical signals that carry digital data streams representing various types of information.

Network link 620 preferable provides data communication through one or more networks to other data devices. For example, network link 620 can provide a connection through local network 622 to a host computer 624 or to data equipment operated by an Internet Service Provider (“ISP”) 626. ISP 626 in turn provides data communication services through Internet 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit requested code for an application program through Internet 628, ISP 626, local network 622 and communication interface 618—for example using the FTP protocol. In accordance with the invention, one such downloaded application is executable software code or computer configuration parameters that perform the methods of the invention.

The received code can be executed by processor 604 as it is received, and/or stored in main memory 606, storage device 610, or other non-volatile storage for later execution. In this manner, computer system 600 can obtain application code in the form of a carrier wave.

Thus, methods for providing an application program interface that allows for the exchange of data between an application server running a decision optimization engine and a client system have been disclosed. While various embodiments of the invention have been shown and described, it will be apparent to those skilled in the art that numerous alterations may be made without departing from the inventive concepts presented herein. Thus, the invention is not to be limited except in accordance with the following claims and their equivalents.

What is claimed is:

1. A method for a client system to exchange data with an application server running a decision optimization engine, comprising:
generating a request document at the client system having one or more request child elements, wherein at least one of the request child elements comprises a command to the decision optimization engine;
sending the request document to the application server; and
receiving a response document from the application server, wherein the response document was generated by the decision optimization engine and comprises one or more response child elements.

2. The method of claim 1, wherein at least one of the response child elements corresponds to at least one of the request child elements.

3. The method of claim 1, wherein the request document is an Extensible Markup Language (XML) document.

4. The method of claim 1, wherein the response document is an Extensible Markup Language (XML) document.

5. A method for an application server running a decision optimization engine to exchange data with a client system, comprising:
receiving a request document from the client system having one or more request child elements, wherein at least one of the request child elements comprises a command for the decision optimization engine;
performing the at least one command contained in the request document using the decision optimization engine;
generating a response document using the decision optimization engine having one or more response child elements; and
sending the response document to the client system.

6. The method of claim 5, wherein at least one of the response child elements corresponds to at least one of the request child elements.

7. The method of claim 5, wherein the request document is an Extensible Markup Language (XML) document.

8. The method of claim 5, wherein the response document is an Extensible Markup Language (XML) document.

9. The method of claim 1, wherein one of the request child elements comprises a credentials element.

10. The method of claim 9, wherein the credentials element comprises at least a first credentials child element, a second credentials child element, and a third credentials child element.

11. The method of claim 10, wherein the first credentials child element comprises an organization element.

12. The method of claim 10, wherein the first credentials child element comprises an enterprise element.

13. The method of claim 10, wherein the second credentials child element comprises a username element.

14. The method of claim 10, wherein the third credentials child element comprises a password element.

15. The method of claim 1, wherein the commands element comprises at least one commands child element instructing the application server to perform at least one of creating a scenario, deleting a scenario, renaming a scenario, copying a scenario, downloading a scenario, updating a scenario, or modifying a scenario.

16. The method of claim 1, wherein the commands element comprises at least one commands child element instructing the application server to retrieve a scenario.

17. The method of claim 1, wherein the commands element comprises at least one commands child element instructing the application server to retrieve a master scenario.

18. The method of claim 1, wherein the commands element comprises at least one commands child element instructing the application server to set a master scenario.

19. The method of claim 1, wherein the commands element comprises at least one commands child element instructing the application server to perform at least one of creating a plan, deleting a plan, renaming a plan, copying a plan, downloading a plan, updating a plan, or modifying a plan.

20. The method of claim 1, wherein the commands element comprises at least one commands child element instructing the application server to retrieve a plan.

21. The method of claim 1, wherein the commands element comprises at least one commands child element instructing the application server to retrieve a master plan.

22. The method of claim 1, wherein the commands element comprises at least one commands child element instructing the application server to set a master plan.

23. The method of claim 1, wherein the commands element comprises at least one commands child element instructing the application server to perform a data analysis.

24. The method of claim 1, wherein the commands element comprises at least one commands child element instructing the application server to regenerate a data analysis.

25. The method of claim 1, wherein the commands element comprises at least one commands child element instructing the application server to a retrieve an analysis.

26. The method of claim 1, wherein the commands element comprises at least one commands child element instructing the application server to perform at least one of aborting an analysis or deleting an analysis.

27. The method of claim 1, wherein the commands element comprises at least one commands child element instructing the application server to perform a risk analysis.

28. The method of claim 1, wherein the commands element comprises at least one commands child element instructing the application server to perform a gated product analysis.

29. The method of claim 1, wherein the commands element comprises at least one commands child element instructing the application server to perform a gating components analysis.

30. The method of claim 1, wherein the commands element comprises at least one commands child element instructing the application server to perform a tornado analysis.

31. The method of claim 1, wherein the commands element comprises at least one commands child element instructing the application server to create an optimal plan.

32. The method of claim 1, wherein the commands element comprises at least one commands child element instructing the application server to regenerate an optimal plan.

33. The method of claim 1, wherein the commands element comprises at least one commands child element instructing the application server to abort an optimal plan.

34. The method of claim 1, wherein the commands element comprises at least one commands child element instructing the application server to load a set of data for an analysis.

35. The method of claim 1, wherein the commands element comprises at least one commands child element instructing the application server to extract source data.

36. The method of claim 1, wherein the commands element comprises at least one commands child element instructing the application server to perform at least one of adding a user, deleting a user, freezing a user, or switching a user.

37. The method of claim 1, wherein the commands element comprises at least one commands child element instructing the application server to perform at least one of creating a planning environment, retrieving a planning environment, loading a planning environment, deleting a planning environment, renaming a planning environment, copying a planning environment, adding a user to a planning environment, removing a user from a planning environment, or changing a user in a planning environment.

38. The method of claim 16, wherein one of the response child elements comprises a scenario.

39. The method of claim 17, wherein one of the response child elements comprises a scenario.

40. The method of claim 18, wherein one of the response child elements comprises a scenario.

41. The method of claim 20, wherein one of the response child elements comprises a plan.

42. The method of claim 21, wherein one of the response child elements comprises a plan.

43. The method of claim 22, wherein one of the response child elements comprises a plan.

44. The method of claim 23, wherein one of the response child elements comprises an analysis.

45. The method of claim 24, wherein one of the response child elements comprises an analysis.

46. The method of claim 25, wherein one of the response child elements comprises an analysis.

47. The method of claim 27, wherein one of the response child elements comprises a risk analysis.

48. The method of claim 28, wherein one of the response child elements comprises a gated products analysis.

49. The method of claim 29, wherein one of the response child elements comprises a gating components analysis.

50. The method of claim 30, wherein one of the response child elements comprises a tornado analysis.

51. The method of claim 3 1, wherein one of the response child elements comprises a plan.

52. The method of claim 32, wherein one of the response child elements comprises a plan.

53. The method of claim 34, wherein one of the response child elements comprises data validation results.

54. The method of claim 35, wherein one of the response child elements comprises source data.

55. A computer-readable medium having stored therein one or more sequences of instructions for a client system to exchange data with an application server running a decision optimization engine, the one or more sequences of instructions causing one or more processors to perform a number of acts, said acts comprising:
generating a request document having one or more request child elements at the client
system, wherein at least one of the request child elements comprises a
command to the decision optimization engine; sending the request document to the application server; and receiving a response document from the application server, wherein the response
document was generated by the decision optimization engine and comprises
one or more response child elements.

56. The method of claim 55, wherein at least one of the response child elements corresponds to at least one of the request child elements.

57. A computer-readable medium having stored therein one or more sequences of instructions for an application server running a decision optimization engine to exchange data with a client system, the one or more sequences of instructions causing one or more processors to perform a number of acts, said acts comprising:
receiving a request document from the client system having one or more request child elements, wherein at least one request child element comprises a command for the decision optimization engine;
performing the at least one command contained in the request document using the decision optimization engine;
generating a response document using the decision optimization engine having one or more response child elements; and
sending the response document to the client system.

58. The method of claim 57, wherein at least one of the response child elements corresponds to at least one of the request child elements.

59. An application server system for exchanging data with a client system, comprising:
a computer that comprises:
a processor;
a main memory communicatively coupled to the processor; and
a storage device communicatively coupled to the processor;
a database running on the computer from the main memory, the database comprising:
one or more data structures relating to one or more request documents stored in the storage device; and
one or more data structures relating to one or more response documents stored in the storage device; and
a decision optimization engine coupled to the database and configured to:
receive a request document from the client system having one or more request child elements, wherein at least one of the request child elements comprises a command for the decision optimization engine;
perform the at least one command contained in the request document;
generate a response document having one or more response child elements; and
send the response document from the application server to the client system.

60. A client system for exchanging data with an application server running a decision optimization engine, comprising:
a computer that comprises:
a processor;
a main memory communicatively coupled to the processor; and
a storage device communicatively coupled to the processor;
a database running on the computer from the main memory, the database comprising:
one or more data structures relating to one or more request documents stored in the storage device; and
one or more data structures relating to one or more response documents stored in the storage device; and
an application program coupled to the database and configured to:
generate a request document having one or more request child elements,
wherein at least one of the request child elements comprises a command for the decision optimization engine;
send the request document from the client system to the application server; and
receive a response document from the application server.

61. An application server system for exchanging data with a client system, comprising:
means for processing information;
means for storing volatile data;
means for storing non-volatile data;
means for receiving a request document from the client system having one or more request child elements, wherein at least one of the request child elements comprises a command;
means for performing the at least one command contained in the request document;
means for generating a response document having one or more response child elements; and
means for sending the response document from the application server to the client system.

62. A client system for exchanging data with an application server, comprising:
means for processing information;
means for storing volatile data;
means for storing non-volatile data;
means for generating a request document having one or more request child elements, wherein at least one request child element comprises a command;
means for sending the request document from the client system to the application server; and
means for receiving a response document from the application server.
